(19) United States
(12) Patent Application Publication
(10) Pub. No.: US 2008/0101178 A1
(43) Pub. Date: May 1, 2008

(54) OPTICAL DISC APPARATUS AND OPTICAL DISC RECORDING METHOD

(75) Inventor: Manabu NOMOTO, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/869,411

(22) Filed: Oct. 9, 2007

(30) Foreign Application Priority Data
Oct. 27, 2006 (JP) 2006-292950

(51) Int. Cl. G11B 5/09; G11B 5/00

(52) U.S. Cl. 369/47.14; 369/47.53

(57) ABSTRACT

According to one embodiment, an optical disc apparatus includes a recording unit that records user data on an optical disc, a generation unit that detects a temperature in the optical disc apparatus and generates a detection signal, a capturing unit that captures the detection signal generated by the generation unit, and a correction unit that corrects a recording power for use in a recording processing on the optical disc preset by an OPC processing based on the detection signal captured by the capturing unit.

### CROSS-REFERENCE TO RELATED APPLICATIONS

This application is based upon and claims the benefit of priority from Japanese Patent Application No. 2006-292950, filed Oct. 27, 2006, the entire contents of which are incorporated herein by reference.

### BACKGROUND

1. Field

One embodiment of the invention relates to an optical disc apparatus and an optical disc recording method. More particularly, it relates to an optical disc apparatus and an optical disc recording method configured so as to be capable of setting an optimum recording power for a disc.

2. Description of the Related Art

There has been proposed a multilayer disc typified by, for example, a two-layer disc for the purpose of increasing the storage capacity. For example, when a recording processing is executed using a two-layer disc, first, a recording processing on a first layer disc is executed for 30 minutes, and then, a jump is made from the first layer disc to the second layer disc, and the processing on the second layer disc is executed for 30 minutes. As a result of this, it is possible to record user data on the two discs (the first layer disc and the second layer disc).

Whereas, in recent years, the following technique (OPC (Optimum Power Control)) has also been proposed. That is, for recording data on a recordable optical disc such as a CD (Compact Disc)-R/RW, or a DVD (Digital Versatile Disc)-R/RW, test data is test written by changing the recording power on a predetermined area (PCA (Power Calibration Area)) of the optical disc. Thus, the test written test data is reproduced, thereby to set the optimum recording power for each disc.

When an OPC processing is executed for the multilayer disc, an OPC processing is executed for each layer disc (such as the first layer disc or the second layer disc), and each optimum recording power is set for every layer disc.

Incidentally, as the technique for setting the optimum recording power for a disc, there is proposed the following technique. Besides, it is disclosed by, for example, JP-A-2004-86940.

In accordance with the technique proposed in JP-A-2004-86940, the information of the temperature in the vicinity of a light source is detected at a predetermined timing. Based on the detected temperature information and the previously obtained temperature characteristic information of the wavelength of a light beam emitted from the light source, the information on the wavelength of the light beam emitted from the light source is captured. Further, the wavelength dependence information of the recording conditions in the information recording medium is captured. Then, based on the captured information on the wavelength and the captured wavelength dependence information of the recording conditions, the recording conditions for recording information on the information recording medium can be corrected. As a result of this, it is possible to suppress the reduction of the recording quality and to obtain good recording quality with stability.

However, for example, when a recording processing is executed by using a two-layer disc, the recording processing on the first layer disc is executed, for example, for 30 minutes, and then, the recording processing on the second layer disc is executed. However, the temperature in the optical disc apparatus largely increases due to the already executed recording processing on the first layer disc. For this reason, the optimum recording power for the second layer disc at the time of start of execution of the recording processing on the second layer disc becomes different from the optimum recording power for the second layer disc preset by an OPC processing. Therefore, even when the optimum recording power for the second layer disc preset by the OPC processing is used, it is not possible to favorably execute the recording processing on the second layer disc, unfavorably resulting in the reduction of the recording quality of the second layer disc.

Such a problem cannot be solved even by using the technique proposed in JP-A-2004-86940, because of the presence of variations from one optical disc apparatus to another.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of an inside of an optical disc apparatus according to one embodiment;

FIG. 2 is an explanatory diagram for illustrating a recording method on a multilayer disc;

FIG. 3 is an explanatory diagram for illustrating an increase in temperature in the optical disc apparatus resulting from a recording processing;

FIG. 4 is a flowchart for illustrating the recording processing in the optical disc apparatus of FIG. 1; and

FIGS. 5A and 5B are diagrams showing wavelength sensitivity characteristics of an optical disc and the wavelength temperature characteristics of a laser light.

### DETAILED DESCRIPTION

Various embodiments according to the invention will be described hereinafter with reference to the accompanying drawings. In general, according to one embodiment of the invention, an optical disc apparatus includes a recording unit that records user data on an optical disc, a generation unit that detects a temperature in the optical disc apparatus and generates a detection signal, a capturing unit that captures the detection signal generated by the generation unit, and a correction unit that corrects a recording power for use in a recording processing on the optical disc preset by an OPC processing based on the detection signal captured by the capturing unit. Further, according to another embodiment of the invention, an optical disc recording method of an optical disc apparatus, includes recording user data on an optical disc, detecting a temperature in the optical disc apparatus, and generating a detection signal, capturing the detection signal, and correcting a recording power for use in a recording processing on the optical disc preset by an OPC processing based on the captured detection signal.

Below, embodiments of the present invention will be described by reference to the accompanying drawings.

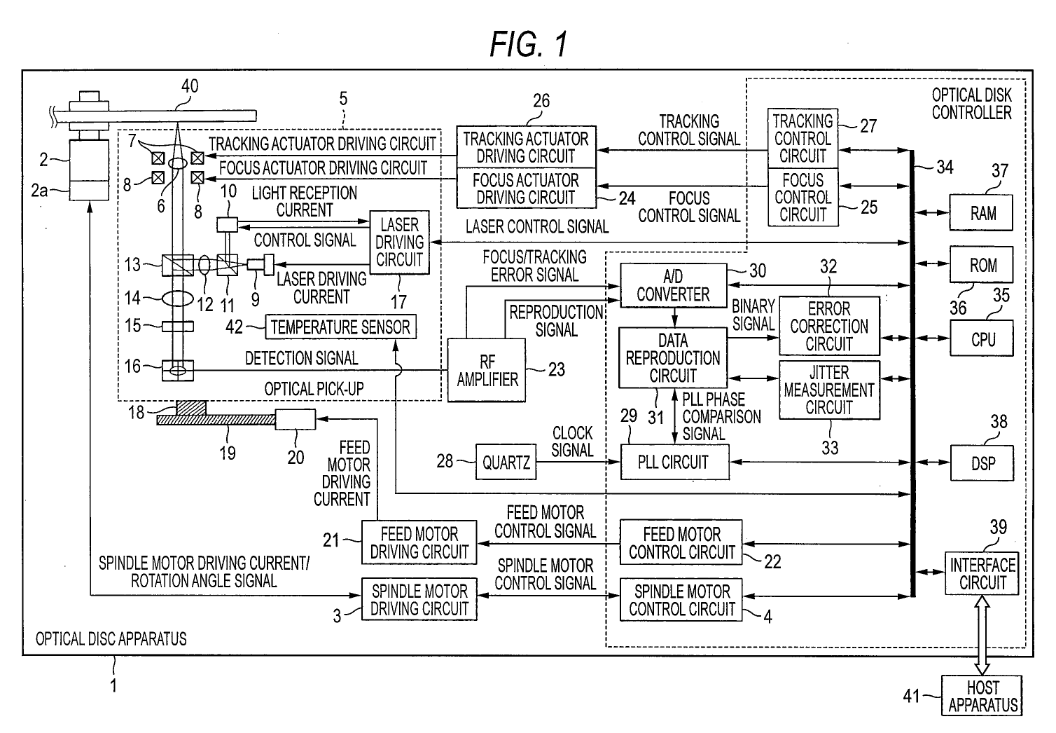

FIG. 1 shows a block diagram showing a configuration of an inside of an optical disc apparatus according to one embodiment.

The optical disc apparatus 1 performs recording and reproducing of information on an optical disc 40 as an information recording medium such as a DVD (Digital Versatile Disc). The optical disc 40 includes channels concentrically or spirally engraved therein. The concave part of the channel is referred to as a land, and the convex part thereof, as a groove. One cycle of the groove or the land is referred to as a track. User data is recorded on the optical disc 40 in the following manner. A laser light modulated in intensity is applied along the track (only the groove, or the groove and the land), so that a recording mark is formed. Data reproduction is carried out by applying a laser light of a weaker read power than for recording along the track, and detecting the changes in reflected light intensity by the recording mark present on the track. The recorded data is erased in the following manner. A laser light of a more intense erase power than the read power is applied along the track, so that the recording layer is crystallized.

Incidentally, the optical disc 40 includes, for example, a two-layer disc (a first layer disc 40-1 and a second layer disc 40-2). It is naturally understood that for the optical disc 40, not only the two-layer disc, but an every multilayer disc such as a four-layer disc can be used.

The optical disc 40 is rotationally driven by a spindle motor 2. A rotation angle signal is outputted from a rotary encoder 2a attached to the spindle motor 2 to a spindle motor driving circuit 3. When the spindle motor 2 makes one rotation, the rotation angle signal generates, for example, 5 pulses. As a result of this, a spindle motor control circuit 4 can judge the angle of rotation and the number of rotations of the spindle motor 2 based on the rotation angle signal inputted from the rotary encoder 2a via the spindle motor driving circuit 3. The spindle motor 2 is controlled by the spindle motor control circuit 4.

Recording or reproducing of information on the optical disc 40 are executed by an optical pick-up 5. The optical pick-up 5 is connected to a feed motor 20 via a gear 18 and a screw shaft 19. The feed motor 20 is controlled by a feed motor driving circuit 21. The feed motor 20 rotates by a feed motor driving current fed from the feed motor driving circuit 21, so that the optical pick-up 5 moves in the direction of radius of the optical disc 40.

The optical pick-up 5 is provided by an objective lens 6 supported by a wire or a blade spring not shown. The objective lens 6 is movable in the focusing direction (the direction of the optical axis of the lens) by driving of a focus actuator 8. Further, it is movable in the tracking direction (the direction orthogonal to the optical axis of the lens) by driving of a tracking actuator 7.

A laser driving circuit 17 supplies a write signal to a laser diode (laser light emitting element) 9 based on recording data supplied from a host apparatus 41 via an interface circuit 39. Whereas, the laser driving circuit 17 supplies a smaller read signal than the write signal to the laser diode 9 for information reading.

A front monitor/photodiode 10 splits a part of a laser light generated by the laser diode 9 only in a given proportion by a half mirror 11. Thus, it detects a light reception signal proportional to the light amount, i.e., the irradiation power, and supplies the detected light reception signal to the laser driving circuit 17. The laser driving circuit 17 captures a light reception signal supplied from the front monitor/photodiode 10. Thus, it controls the laser diode 9 so as to emit light at a laser power for reproduction (irradiation power), a laser power for recording, and a laser power for erasure, preset by the CPU 35 based on the captured light reception signal.

The laser diode 9 emits a laser light in response to a signal supplied from the laser driving circuit 17. The laser light emitted from the laser diode 9 is applied on the optical disc 40 via a collimator lens 12, a half prism 13, and the objective lens 6. A reflection light from the optical disc 40 is guided to a photodetector 16 via the objective lens 6, the half prism 13, a condensing lens 14, and a cylindrical lens 15.

The photodetector 16 includes, for example, a four-divided photodetector cell, and generates a detection signal, and outputs the generated detection signal to a RF amplifier 23. The RF amplifier 23 processes a detection signal from the photodetector 16, and generates a focus error signal (FE) indicative of the error from just focus, a tracking error signal (TE) indicative of the error between the beam spot center of the laser light and the track center, and a reproduction signal (RF) which is a full-added signal of detection signals. Thus, it supplies the generated focus error signal (FE), tracking error signal (TE), and reproduction signal (RF) to an A/D converter 30.

A focus control circuit 25 generates a focus control signal in response to a focus error signal (FE) captured from the RF amplifier 23 to a DSP 38 via the A/D converter 30. Thus, it supplies the generated focus control signal to a focus actuator driving circuit 24. The focus actuator driving circuit 24 supplies a focus actuator driving current for driving the focus actuator 8 to the focus actuator 8 in the focusing direction based on a focus control signal supplied from the focus control circuit 25. As a result of this, focus servo is carried out such that the laser light is normally just focused on the recording film of the optical disc 40.

A tracking control circuit 27 generates a track control signal in response to a tracking error signal (TE) captured from the RF amplifier 23 to the DSP 38 via the A/D converter 30. Thus, it supplies the generated track control signal to a tracking actuator driving circuit 26. The tracking actuator driving circuit 26 supplies a tracking actuator driving current for driving the tracking actuator 7 to the tracking actuator 7 in the tracking direction based on a tracking control signal supplied from the tracking control circuit 27. As a result of this, tracking servo is carried out such that the laser light normally traces on the track formed on the optical disc 40.

Such focus servo and tracking servo are carried out. As a result, on the reproduction signal (RF) which is the full-added signal of the detection signals from the photodetector 16 (each photodetector cell), changes in reflection light from a pit formed on the track of the optical disc 40 corresponding to the recording information, and the like are reflected. The reproduction signal is supplied to a data reproduction circuit 31 via the A/D converter 30. The data reproduction circuit 31 generates a binary signal of 1 or 0 in response to a reproduction signal supplied from the A/D converter 30, and outputs the generated binary signal to an error correction circuit 32. Whereas, the data reproduction circuit 31 outputs a binary signal to the error correction circuit 32, and at the same time, generates the phase difference between the reproduction clock signal supplied from a PLL (Phase Locked Loop) circuit 29 and the binary signal as a PLL phase comparison signal, and generates the generated PLL phase comparison signal to the PLL circuit 29.

A jitter measurement circuit 33 measures the jitter of the reproduction signal from the reproduction signal supplied from the A/D converter 30 and the reproduction clock signal generated at the PLL circuit 29. The measured jitter measurement signal is readable by the CPU 35 via a bus 34.

The DSP (Digital Signal Processor) 38 performs various operation processings on digital signals such as a focus error signal (FE) and a tracking error signal (TE) outputted from the RF amplifier 23, and then converted into digital signals via the A/D converter 30. Thus, it controls the spindle motor control circuit 4, a feed motor control circuit 22, the focus control circuit 25, and the tracking control circuit 27.

The spindle motor control circuit 4, the feed motor control circuit 22, the focus control circuit 25, and the tracking control circuit 27 are controlled by the DSP 38 via the bus 34.

Whereas, the laser driving circuit 17, the PLL circuit 29, the A/D converter 30, the error correction circuit 32, the jitter measurement circuit 33, the DSP 38, the temperature sensor 42, and the like are controlled by the CPU (Central Processing Unit) 35 via the bus 34. The CPU 35 follows an operation command supplied from the host apparatus 41 via the interface circuit 39, and executes various processings in accordance with the program stored in a ROM (Read Only Memory) 36, and the program loaded from the ROM 36 to a RAM (Random Access Memory) 37. Thus, the CPU 35 generates various control signals, and supplies them to respective parts, and thereby controls the optical disc apparatus 1 in a centralized manner.

The temperature sensor 42 is provided in the inside of the optical pick-up 5, and follows the control of the CPU 35. Thus, it detects, for example, the temperature in the vicinity of the laser diode 9 in the optical disc apparatus 1, generates a detection signal, and appropriately supplies the generated detection signal to the CPU 35 via the bus 34. Incidentally, in the embodiments of the invention, the temperature sensor 42 was disposed in the vicinity of, particularly, the laser diode 9 in the optical pick-up 5. However, the invention is not limited to such a case, and the temperature sensor 42 may be provided outside the optical pick-up 9.

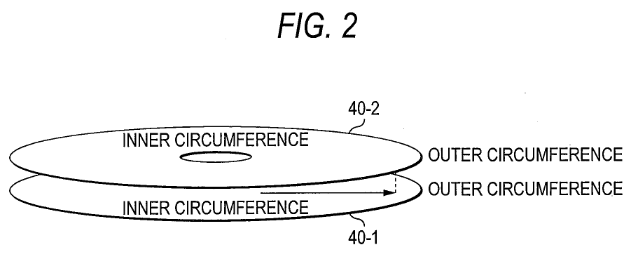

Incidentally, for example, when a recording processing is executed by the use of the optical disc 40 which is a two-layer disc, the recording processing on the first layer disc 40-1 is executed for, for example 30 minutes, and then the recording processing on the second layer disc 40-2 is executed. Specifically, as shown in FIG. 2, for example, first, by using the optimum recording power for the first layer disc preset by an OPC processing, recording processings are sequentially executed from the inner circumference side toward the outer circumference side of the first layer disc 40-1. Then, a jump is made from the first layer disc 40-1 to the second layer disc 40-2. Then, by using the optimum recording power for the second layer disc preset by an OPC processing, recording processings are sequentially executed from the outer circumference side toward the inner circumference side of the second layer disc 40-2.

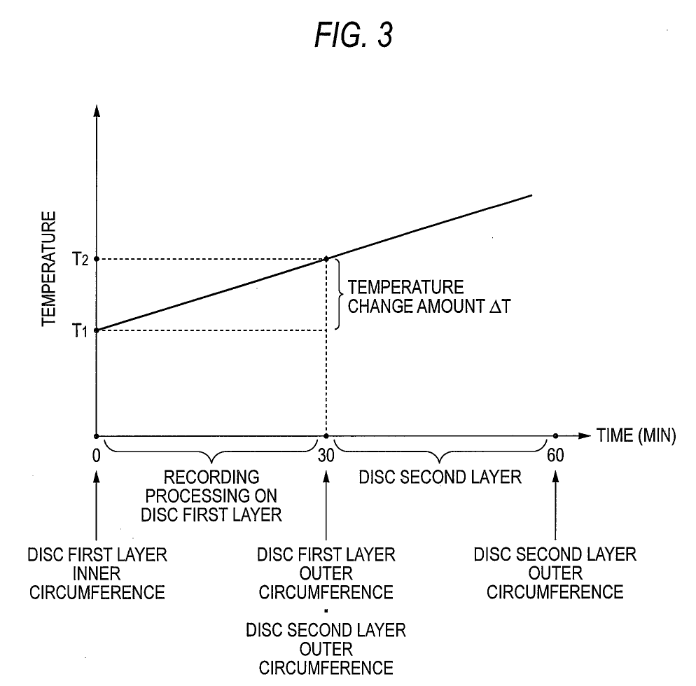

However, the temperature in the vicinity of the laser diode 9 largely increases due to the already executed recording processing on the first layer disc 40-1. For example, as shown in FIG. 3, at the time of start of execution of the recording processing on the first layer disc 40-1, the temperature in the vicinity of the laser diode 9 is T₁ (° C.). However, at the time of start of execution of the recording processing on the second layer disc 40-2, the temperature in the vicinity of the laser diode 9 is T₂ (° C.) Namely, at the time of start of execution of the recording processing on the second layer disc 40-2, the temperature in the vicinity of the laser diode 9 increases than at the time of start of execution of the recording processing on the first layer disc 40-1 by ΔT (T₁-T₂) (° C.). More specifically, for example, the temperature in the vicinity of the laser diode 9 increases from 25 (° C.) to about 45 (° C.).

For this reason, the optimum recording power for the second layer disc 40-2 at the time of start of execution of the recording processing of the second layer disc 40-2 becomes different from the optimum recording power for the second layer disc 40-2 preset by an OPC processing. As a result, even when the optimum recording power for the second layer disc 40-2 preset by the OPC processing is used, it is not possible to favorably execute the recording processing on the second layer disc 40-2, unfavorably resulting in the reduction of the recording quality of the second layer disc 40-2.

Under such circumstances, at the time of start of execution of the recording processing on the first layer disc 40-1, the temperature in the vicinity of the laser diode 9 is detected (measured) by using the temperature sensor 42 provided in the optical disc apparatus 1. In addition, at the time of start of execution of the recording processing on the second layer disc 40-2, the temperature in the vicinity of the laser diode 9 is detected by using the temperature sensor 42 provided in the optical disc apparatus 1. Thus, by using the difference in temperature in the vicinity of the laser diode 9 between at the time of start of execution of respective recording processings of the first layer disc 40-1 and the second layer disc 40-2, the optimum recording power for the second layer disc 40-2 preset by the OPC processing is corrected. As a result of this, it becomes possible to correct the recording power according to the changes in temperature in the vicinity of the laser diode 9. Below, the recording processing in the optical disc apparatus 1 in FIG. 1 using this method will be described.

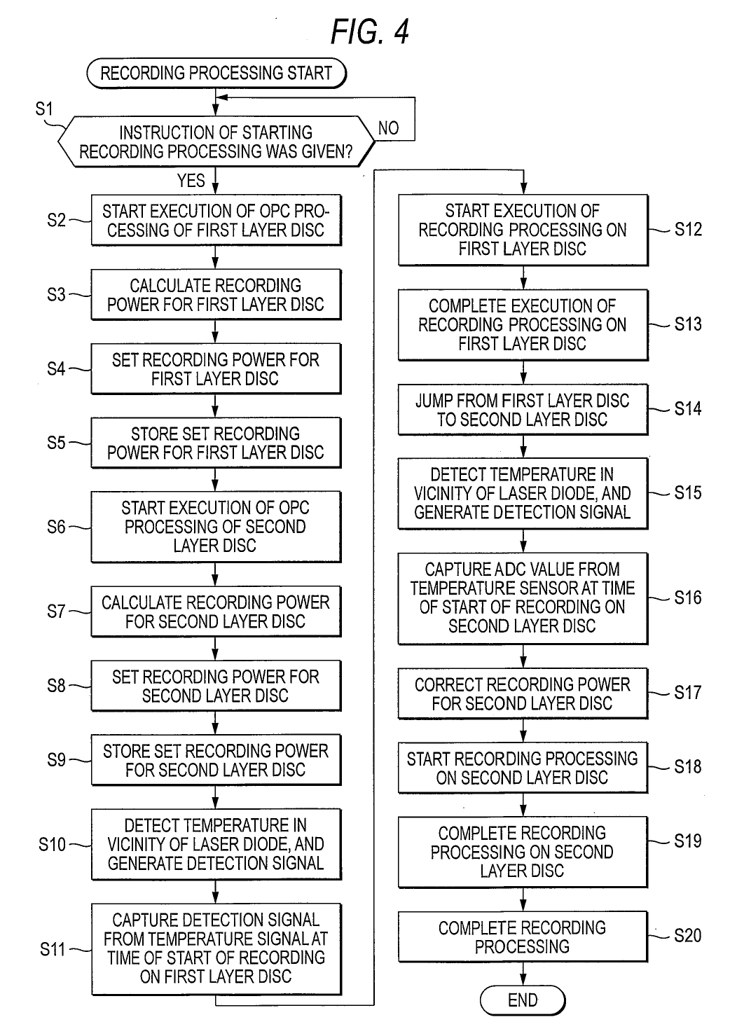

By reference to a flowchart of FIG. 4, the recording processing in the optical disc apparatus 1 of FIG. 1 will be described. This recording processing is started in the following manner. The input unit not shown of the host apparatus 41 is operated by a user, so that an instruction of starting a recording processing is sent.

In a step S1, the CPU 35 judges whether or not an instruction of starting a recording processing has been made by a user's operation of the input unit not shown of the host apparatus 41. Then, the CPU 35 waits until it judges that an instruction of starting a recording processing has been made by a user's operation of the input unit not shown of the host apparatus 41.

In the step S1, when it is judged that an instruction of starting a recording processing has been made by a user's operation of the input unit not shown of the host apparatus 41, the CPU 35 controls, in the step S2, the pick-up 5, the focus control circuit 25, the tracking control circuit 27, and the like to execute an OPC processing of the first layer disc 40-1. Incidentally, for executing the OPC processing, for example, the optimum recording power for the first layer disc 40-1 (or the second layer disc 40-2) is set by a method using the asymmetry of a reproduction signal, or a method using jitter.

In a step S3, the CPU 35 calculates the optimum recording power for the first layer disc 40-1. In a step S4, the CPU 35 sets the optimum recording power for the first layer disc 40-1 based on the calculated result, and supplies the first layer disc recording power setting data which is data on the set optimum recording power for the first layer disc 40-1 to, for example, the RAM 37, or a nonvolatile memory not shown.

In a step S5, the RAM 37, the nonvolatile memory not shown, or the like follows the control of the CPU 35, and stores the first layer disc recording power setting data which is data on the set optimum recording power for the first layer disc 40-1.

In the step S6, the CPU 35 starts the execution of the OPC processing of the second layer disc 40-2. In a step S7, the CPU 35 calculates the optimum recording power for the second layer disc 40-2. In a step S8, the CPU 35 sets the optimum recording power for the second layer disc 40-2 based on the calculated result, and supplies the second layer disc recording power setting data which is data on the set optimum recording power for the second layer disc 40-2 to, for example, the RAM 37, or a nonvolatile memory not shown.

In a step S9, the RAM 37, the nonvolatile memory not shown, or the like follows the control of the CPU 35, and stores the second layer disc recording power setting data which is data on the set optimum recording power for the second layer disc 40-2.

In a step S10, the temperature sensor 42 follows the control of the CPU 35. Thus, it detects the temperature in the vicinity of the laser diode 9 at the time of starting the execution of the recording processing on the first layer disc 40-1, thereby to generate a detection signal, and supplies the generated detection signal to the CPU 35 via the bus 34.

In a step S11, for the start of the execution of the recording processing on the first layer disc 40-1, the CPU 35 captures a detection signal (ADC (analog to digital converter) value T₁) from the temperature sensor 42 generated upon detection of the temperature in the vicinity of the laser diode 9 at the time of start of the execution of the recording processing on the first layer disc 40-1.

In a step 12, the CPU 35 reads the first layer disc recording power setting data which is data on the optimum recording power for the first layer disc 40-1 preset by the OPC processing, stored in, for example, the RAM 37 or the nonvolatile memory not shown. In addition, the CPU 35 controls the optical pick-up 5, the focus control circuit 25, the tracking control circuit 27, and the like. Thus, based on the read first layer disc recording power setting data, the CPU 35 starts the execution of the recording processing on the first layer disc 40-1 using the optimum recording power for the first layer disc 40-1 preset by the OPC processing. In a step S13, the CPU 35 controls the optical pick-up 5, the focus control circuit 25, the tracking control circuit 27, and the like, and completes the execution of the recording processing on the first layer disc 40-1. As a result of this, for example, the recording processing from the inner circumferential side toward the outer circumferential side of the first layer disc 40-1 is executed for 30 minutes, so that user data is recorded on the first layer disc 40-1.

In a step S14, the CPU 35 controls the optical pick-up 5, the focus control circuit 25, the tracking control circuit 27, and the like. Thus, a jump is made from the first layer disc 40-1 to the second layer disc 40-2. For example, the CPU 35 causes a jump to be made from the outer circumferential side of the first layer disc 40-1 to the outer circumferential side of the second layer disc 40-2.

In a step S15, the temperature sensor 42 follows the control of the CPU 35. Thus, it detects the temperature in the vicinity of the laser diode 9 at the time of start of the execution of the recording processing on the second layer disc 40-2, thereby to generate a detection signal, and supplies the generated detection signal to the CPU 35 via the bus 34.

Then, in a step S16, for the start of the execution of the recording processing on the second layer disc 40-2, the CPU 35 captures a detection signal (ADC value T₂) from the temperature sensor 42 generated upon detection of the temperature in the vicinity of the laser diode 9 at the time of start of the execution of the recording processing on the second layer disc 40-2.

In a step 17, the CPU 35 reads the second layer disc recording power setting data which is data on the optimum recording power for the second layer disc 40-2 stored in the RAM 37, the nonvolatile memory not shown, or the like (the optimum recording power for the second layer disc 40-2 preset by the OPC processings in the steps S6 to S9). In addition, the CPU 35 corrects the optimum recording power for the second layer disc 40-2 preset by the OPC processing based on the captured detection signal (ADC value T₁) from the temperature sensor 42 generated upon detection of the temperature in the vicinity of the laser diode 9 at the time of start of the execution of the recording processing on the first layer disc 40-1, a detection signal (ADC value T₂) from the temperature sensor 42 generated upon detection of the temperature in the vicinity of the laser diode 9 at the time of start of the execution of the recording processing on the second layer disc 40-2, and the second layer disc recording power setting data.

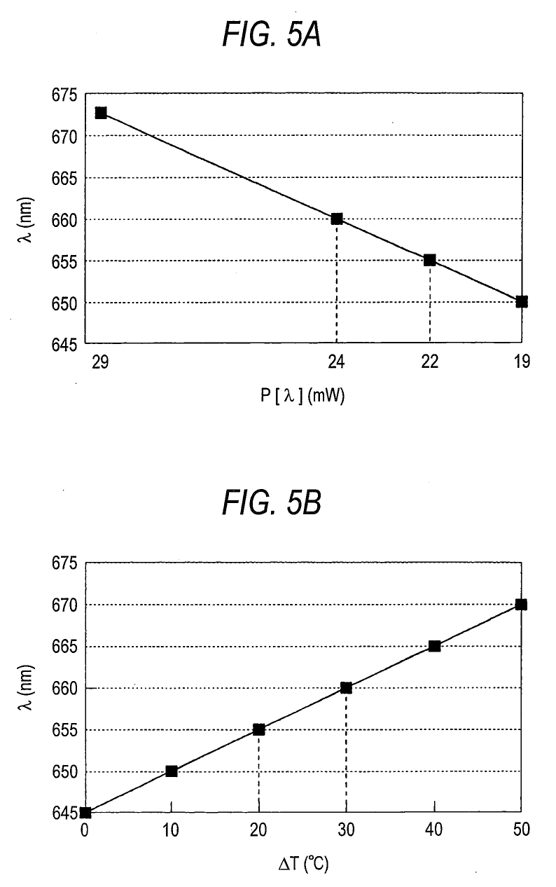

Herein, the optical disc 40 has specific wavelength sensitivity characteristics, and it has, for example, the wavelength sensitivity characteristics as shown in FIG. 5A. For example, in the case of FIG. 5A, the power value of the recording power for use in recording user data on the optical disc 40 is required to be increased with an increase in wavelength of the laser light to be applied from the laser diode 9. In other words, the recording sensitivity decreases as the wavelength of the laser light to be applied from the laser diode 9 shifts toward the longer wavelength side. Specifically, it is assumed that the power value of the recording power for use in recording of user data on the optical disc 40 is, for example, 22 mW when the wavelength of the laser light to be applied from the laser diode 9 is 655 nm. In this case, when the wavelength of the laser light to be applied from the laser diode 9 becomes 660 nm, the power value of the recording power for use in recording of the user data on the optical disc 40 is required to be set at, for example, 24 mW.

Whereas, for example, as shown in FIG. 5B, for the laser light to be applied from the laser diode 9, there are present wavelength temperature characteristics. As the temperature in the vicinity of the laser diode 9 increases, the wavelength of the laser light to be applied from the laser diode 9 shifts toward the longer wavelength side. For example, in the case of FIG. 5B, it is assumed that the wavelength of the laser light to be applied from the laser diode 9 is 655 nm when the temperature in the vicinity of the laser diode 9 is 20 (° C.). In this case, when the temperature in the vicinity of the laser diode 9 becomes 30 (° C.), the wavelength of the laser light to be applied from the laser diode 9 becomes 660 nm.

Under such circumstances, for example, in the cases of FIGS. 5A and 5B, when the temperature in the vicinity of the laser diode 9 changes from 20 (° C.) to 30 (° C.) between the time of start of the execution of the recording processing on the first layer disc 40-1 and the time of start of the execution of the recording processing on the second layer disc 40-2 (i.e., ΔT is 10 (° C.)), correction is made by multiplying the optimum recording power for the second layer disc 40-2 preset by the OPC processing by a predetermined correction factor (24 nW/22 nW=1.09) by using the wavelength sensitivity characteristics and the wavelength temperature characteristics.

In a step S18, the CPU 35 controls the optical pick-up 5, the focus control circuit 25, the tracking control circuit 27, and the like. Thus, the CPU 35 starts the execution of the recording processing on the second layer disc 40-2 by using the corrected optimum recording power for the second layer disc 40-2 (the recording power obtained by correcting the optimum recording power for the second layer disc 40-2 preset by the OPC processing by the correction processing). In a step S19, the CPU 35 controls the optical pick-up 5, the focus control circuit 25, the tracking control circuit 27, and the like, and completes the execution of the recording processing on the second layer disc 40-2. As a result of this, for example, the recording processing from the outer circumferential side toward the inner circumferential side of the second layer disc 40-2 is executed for 30 minutes, so that user data is recorded on the second layer disc 40-2.

In a step S20, the CPU 35 completes the recording processing.

In the embodiments of the invention, it is possible to capture a detection signal (ADC value T₁) from the temperature sensor 42 generated upon detection of the temperature in the vicinity of, for example, the laser diode 9 in the optical disc apparatus 1 at the time of start of the execution of the recording processing on the first layer disc 40-1. In addition, it is possible to capture a detection signal (ADC value T₂) from the temperature sensor 42 generated upon detection of the temperature in the vicinity of, for example, the laser diode 9 in the optical disc apparatus 1 at the time of start of the execution of the recording processing on the second layer disc 40-2. Then, it is possible to correct the optimum recording power for the second layer disc 40-2 preset by the OPC processing based on the captured detection signal (ADC value T₁) from the temperature sensor 42 generated upon detection of the temperature in the optical disc apparatus 1 at the time of start of the execution of the recording processing on the first layer disc 40-1, and detection signal (ADC value T₂) from the temperature sensor 42 generated upon detection of the temperature in the optical disc apparatus 1 at the time of start of the execution of the recording processing on the second layer disc 40-2, and the second layer disc recording power setting data.

As a result of this, it is possible to correct the recording power for use in recording user data on the optical disc 1 in accordance with the changes in temperature in the vicinity of, for example, the layer diode 9 in the optical disc apparatus 1. Therefore, even when the temperature in the vicinity of, for example, the laser diode 9 in the optical disc apparatus 1 changes due to the long-time recording processing, it is possible to execute the recording processing suitable for the optical disc 40. Particularly, when the optical disc 40 is a multilayer disc, suitable recording processings can be executed on respective layer discs. As a result, it is possible to improve the recording quality of the optical disc 40.

Incidentally, in the embodiments of the invention, when the process shifts from the recording processing on the first layer disc 40-1 to that on the second layer disc 40-2, the recording power preset by the OPC processing is corrected. However, the invention is not limited to such a case. For example, the correction processing of the recording power may be carried out during the recording processing on the first layer disc 40-1. Alternatively, such a correction processing may be carried out plural times. As a result of this, even when the temperature in the vicinity of, for example, the laser diode 9 in the optical disc apparatus 1 changes due to the long-time recording processing, it is possible to execute a more suitable recording processing for the optical disc 40 according to the changes in temperature. As a result, it is possible to improve the recording quality of the optical disc 40.

Further, the invention can be applied not only to a multilayer disc, but also, of course, to a monolayer disc.

Incidentally, in the embodiments of the invention, for the steps of the flowchart, examples of the processing to be executed in time sequence in accordance with the order described were described. However, they include the processings to be executed in parallel, or individually even though they are not necessarily executed in time sequence.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a recording unit that records user data on an optical disc;
a generation unit that detects a temperature in the optical disc apparatus, and generates a detection signal;
a capturing unit that captures the detection signal generated by the generation unit; and
a correction unit that corrects a recording power for use in a recording processing on the optical disc preset by an OPC processing based on the detection signal captured by the capturing unit.

2. The optical disc apparatus according to claim 1,
wherein the recording unit records user data on the optical disc using the recording power corrected by the correction unit.

3. The optical disc apparatus according to claim 1,
wherein the optical disc includes a first layer disc and a second layer disc.

4. The optical disc apparatus according to claim 3,
wherein the capturing unit captures a detection signal generated by the generation unit for recording user data on the first layer disc by the recording unit, and for recording user data on the second layer disc by the recording unit.

5. The optical disc apparatus according to claim 1,
wherein the generation unit generates the detection signal based on an amount of changes in temperature in the optical disc apparatus.

6. An optical disc recording method of an optical disc apparatus, comprising:
recording user data on an optical disc;
detecting a temperature in the optical disc apparatus, and generating a detection signal;
capturing the detection signal; and
correcting a recording power for use in a recording processing on the optical disc preset by an OPC processing based on the captured detection signal.
